(19) United States
(12) Patent Application Publication
(10) Pub. No.: US 2023/0347565 A1
(43) Pub. Date: Nov. 2, 2023

(54) HYDRAULIC SYSTEM FOR A MOLDING MACHINE

(71) Applicant: ENGEL AUSTRIA GmbH, Schwertberg (AT)

(72) Inventors: Markus OTTO, Ernsthofen (AT); Peter WAGNER, Neuhofen an der Ybbs (AT)

(21) Appl. No.: 18/139,554

(22) Filed: Apr. 26, 2023

(30) Foreign Application Priority Data
Apr. 29, 2022 (AT) A 50291/2022

(51) Int. Cl. B29C 45/82; B29C 45/67

(52) U.S. Cl. CPC B29C 45/82; B29C 45/67; B29C 2945/76785; B29C 2945/76307

(57) ABSTRACT

A hydraulic system for a molding machine with a hydraulic valve, includes an actuator for positioning the hydraulic valve, a machine control system realized separate from the hydraulic valve, a first signal connection between the machine control system and the hydraulic valve, and a sensor. The sensor is signal-connected to the machine control system via a second signal connection, and the machine control system is formed to carry out a valve regulation of the hydraulic valve on the basis of measured values of the sensor.

### BACKGROUND OF THE INVENTION

The present invention relates to a hydraulic system for a molding machine, as well as a molding machine with such a hydraulic system.

By molding machines may be meant injection-molding machines, transfer-molding machines, presses and the like. Molding machines in which a plasticized material is supplied to an open mold are also entirely conceivable.

The state of the art is to be outlined below with reference to an injection-molding machine. This applies analogously to molding machines in general.

Generic hydraulic systems for a molding machine comprise:
at least one hydraulic valve, which contains an actuator for positioning the at least one hydraulic valve,
a machine control system realized separate from the at least one hydraulic valve,
a first signal connection between the machine control system and the at least one hydraulic valve, as well as
at least one sensor.

In known embodiments of the state of the art of injection-molding machines, a large number of component parts of the injection-molding machine are usually driven by a hydraulic system.

To control or regulate these drive movements, the hydraulic system usually has at least one hydraulic valve.

In order to move the hydraulic valve into different valve positions, the at least one hydraulic valve in turn has an actuator, for example a solenoid actuator.

In order furthermore also to be able to ascertain whether the valve is occupying the correct position, a sensor is provided which can directly measure the valve position or an alteration of the hydraulic system executed by the valve position.

Thus, for example, flow rates, pressures or other operating parameters of the hydraulic system, which can be altered by the at least one hydraulic valve, can be measured by the sensor.

In common embodiment variants of the state of the art, a regulation or control of the hydraulic system is carried out as explained below.

First, a target state for a movement or an operating parameter of the hydraulic system is output by a machine control system separate from the hydraulic system, wherein usually the machine control system only generally outputs a target value which defines that for example a certain target pressure and/or flow value is provided for a drive of a machine component by the hydraulic system.

The machine control system usually forms a superordinate machine control system which is responsible for the cooperation of the individual components of the injection-molding machine (such as for example the control of the injection unit, the plasticizing unit and the clamping unit).

This general target value signal is then sent to a valve control system of the hydraulic valve, wherein the valve control system converts this general target value to a valve target value which is to be executed by the valve in order to achieve the general target value. The valve control system in turn transmits this target value to power electronics.

The power electronics convert the valve target value to a corresponding actuation signal (usually an analog actuation signal) and supply it to the actuator of the hydraulic valve, which occupies and/or changes a position on the basis of the actuation signal.

Via a sensor of the hydraulic system, a measured value is then collected, which is returned either to the valve control system or to the power electronics.

The valve control system or power electronics calculate an actual value of the hydraulic system from the measured value and correct the target signal on the basis of this actual value. The actuation signal is subsequently correspondingly adapted for the hydraulic valve in order to achieve the general target value of the machine control system.

This follows correspondingly, for example, from EP 0 967 400 A2 or U.S. Pat. No. 6,053,707 A.

However, only (in the best case) an actual value is returned to the machine control system.

However, in the prevalent cases, the machine control system does not receive feedback about the measured value of the sensor, the actuation signal present or output to the hydraulic valve or measured values of the valve control system or the power electronics used elsewhere in the regulation.

This procedure evolved in the state of the art among other things from the fact that different components from different manufacturers are combined in injection-molding machines in order to implement a total system. Manufacturers of valve systems supply their own valve control system, which are assembled according to the valve manufacturers' notions.

A disadvantage of this, however, is that very complex and powerful valve control systems usually result, which are usually not needed in use.

A further disadvantage is that the machine control system obtains no information about many measured values and control effects, whereby the coordination, improvement or also simplification of many control or regulation interventions is not made possible either.

### SUMMARY OF THE INVENTION

The object of the present invention is therefore to provide a hydraulic system for a molding machine, wherein the above-named disadvantages of the state of the art are at least partially improved and/or the hydraulic system is simplified compared with the state of the art and/or a hydraulic system can be adapted in a task-specific manner with respect to its potential and/or the hydraulic system of the molding machine provides greater possibilities for optimization.

This object is achieved by a hydraulic system for a molding machine as described below, a molding machine with a corresponding hydraulic system as well as a computer program product for operating a hydraulic system.

According to the invention, a hydraulic system for a molding machine comprises the following:
at least one hydraulic valve, which contains an actuator for controlling the at least one hydraulic valve,
a machine control system realized separate from the at least one hydraulic valve,
a first signal connection between the machine control system and the at least one hydraulic valve, and
at least one sensor.

The at least one sensor is—in particular directly—signal-connected to the machine control system via at least one second signal connection and the machine control system is formed to carry out a valve regulation of the at least one hydraulic valve on the basis of measured values of the at least one sensor.

Because the machine control system undertakes the valve regulation on the basis of measured values of the at least one sensor, a valve control system assigned to the hydraulic valve can be dispensed with, and the machine control system, as central control unit of the machine, undertakes the function of the valve regulation.

The invention thus creates the possibility that all resultant control or regulating signals and measured values of the machine control system are known, whereby it is made possible that the machine control system can also take other influencing parameters into account in the valve regulation and can control or regulate the hydraulic valve in a more targeted manner.

Furthermore, it is no longer necessary to provide separate electronics for regulating the valve, and these overdimensioned valve electronics can usually be economized on.

Through the integration of the valve regulation in the machine control system, only a situation-based processor power can furthermore also be provided in a targeted manner by the machine control system, with the result that optimum use is made of the machine control system and unused processor capacities can be used, for example for other processes.

Moreover, the advantage is created that, for example for updates, a central unit—the machine control system—is implemented, wherein only the machine control system has to be updated in order to remain up to date, and it is not necessary, as known in the state of the art, to maintain and update each individual control or regulating unit separate from each other (usually by different maintenance personnel).

A further advantage is that the machine control system can be freely positioned in its area of application—more precisely: in its position—whereby a protected and optimum operating environment can be created. In embodiments known from the state of the art, wherein a valve control system is arranged directly on the valve, due to operating conditions of the injection-molding machine, these valve control systems are often exposed to high temperatures or other influences which have a disadvantageous effect on the lifespan of the control system.

As mentioned, the machine control system within the meaning of the invention is the hardware component of the hydraulic system which is formed or at least suitable to control and/or regulate substantially all of the functions of the hydraulic system and preferably of the molding machine.

The machine control system can of course also contain software components, which are executed by the machine control system.

It is to be mentioned that the machine control system can also have additional computing units arranged remote from the molding machine (distributed computing). The additional computing units can be realized, for example, as servers and/or edge devices connected via the internet.

The software components mentioned can in each case be executed wholly or partially in the actual machine control system and/or the additional computing units.

The software components mentioned can be implemented, for example, as one or more control modules in an existing machine control system.

Thus, already existing machine control systems are expanded by a further control module, which represents a machine control system according to the invention.

As a result, it would be possible for a control module for example to be implemented, maintained and/or updated by a valve manufacturer in the machine control system of a molding machine. As a result of which, for example, liability can also be assumed by a valve manufacturer who provides the control module, even if the control module was implemented on a machine control system from a molding machine manufacturer independent of the valve manufacturer.

An implementation of a corresponding control module in a machine control system of a molding machine can be effected for example using the following interfaces, wherein use can be made of the listed advantages:
external C library
   call up in the IEC 61131-3 runtime system
IEC 61131-3 library
   direct instantiation of the library in the IEC 61131-3 control software
C application in the real-time system
   independent C application in the real-time system of the machine control system
   communication with the IEC 61131-3 control software via inter-process communication
C/C++ application in the user space
   independent C/C++ application outside the real-time system
   hard real-time requirements are achievable.

The interface of the machine control system with the control module can be defined for example with a supplier of the control module. Essentially, however, the interface can be composed of process data (cyclic input/output parameters) and an asynchronous parameter exchange.

An example of such an interface:
process data input
   REAL target value pressure [bar]
   REAL actual value pressure [bar]
   REAL target value swivel angle [%]
   REAL actual value swivel angle [%]
   REAL actual value valve position [%]
   REAL actual value rotational speed [%] (for example for adaptation of the control parameters dependent on rotational speed)
   DINT control parameter set (for an example of the choice of a particular control parameter set based on the active machine movement)
process data output
   REAL target value valve position [%]
   asynchronous communication
   DINT ParamIndex
   DINT ParamSubIndex
   DINT mode [READ,WRITE]
   REAL value
   DINT value
   STRING value
asynchronous communication
   REAL target value valve position [%]
   asynchronous communication
   DINT ParamIndex
   DINT ParamSubIndex
   DINT mode [READ,WRITE]
   REAL value
   DINT value
   STRING value

A signal-carrying connection is to be understood, in the course of the document, as a connection for transmitting signals, which can be formed as a signal-carrying wire or also as a wireless connection. The signal-carrying connection can moreover be formed as a remote data transmission connection.

The remote data transmission connection can be realized by means of a LAN (Local Area Network), WLAN (Wireless Local Area Network), WAN (Wide Area Network) and/or different (internet) protocols.

Molding machines can include injection-molding machines, transfer-molding machines, presses and the like. Molding machines in which the plasticized material is supplied to an opened mold are also entirely conceivable.

Through its use in already known embodiment variants of the state of the art, as described for example in the introduction to the description, a device according to the invention can also be used and subsequently installed.

The machine control system can be formed to generate and output an actuation signal for the actuator of the at least one hydraulic valve from a correcting variable resulting from the valve regulation, with the result that the actuator can be actuated by the actuation signal transmitted via the signal connection.

Preferably, an actuation signal can be output directly by the machine control system, whereby the function of the power electronics is executed by the machine control system.

Separate power electronics can thus also be dispensed with, and further correcting variables and signals resulting from operation can be influenced directly on the machine control system, recorded and used for other processes, whereby no signal values escape the machine control system.

Preferably, the machine control system is formed to generate and output an analog actuation signal of the at least one hydraulic valve.

The hydraulic system can have at least one fluid pump and a drive coupled to this fluid pump, which drive and/or at least one fluid pump is preferably signal-connected to the machine control system with a further signal connection.

Preferably, the at least one fluid pump and/or the drive of the at least one fluid pump is controlled or regulated by the machine control system, whereby for example a control or regulation of the hydraulic system can also be effected via the rotational speed of the fluid pump. The machine control system can take this into account or use it in the control or regulation of the hydraulic valve.

Preferably, the at least one fluid pump is formed adjustable with respect to its displacement volume, preferably is formed as an axial piston pump with adjustable swivel angle.

The fluid pump can be continuously settable or adjustable with respect to its displacement volume, or can have two or more discrete pump settings.

Preferably, at least one hydraulic actuator, preferably a piston-cylinder unit, is connected in a fluid-carrying manner to the hydraulic valve, and the hydraulic actuator can set a displacement volume of the at least one fluid pump.

Thus, a small hydraulic actuator, preferably cylinder, can directly influence the adjustment angle of a fluid pump.

The machine control system can be formed to set a displacement volume of the at least one fluid pump on the basis of a correcting variable resulting from the valve regulation by means of the at least one hydraulic valve and/or hydraulic actuator.

Preferably, the machine control system can be formed to generate and output the actuation signal for the actuator of the at least one hydraulic valve taking into account a displacement volume of the at least one fluid pump and/or an operating state of the drive of the fluid pump.

The at least one sensor can be formed as a pressure sensor and/or flow sensor, and a signal representative of the pressure and/or the flow can be provided to the machine control system.

Preferably, the at least one sensor is formed as a position sensor, preferably a swivel angle sensor, of the at least one fluid pump.

The hydraulic system can have at least one drive unit for driving at least one machine component, preferably a clamping unit and/or plasticizing unit and/or injection unit of the molding machine, wherein the machine control system is formed to control or regulate a movement, speed and/or position of the at least one machine component.

The at least one drive unit can be formed to drive the at least one machine component rotationally and/or linearly, for example to carry out a closing or opening of the clamping unit, to apply a clamping force to a machine component, to press on an injection and/or plasticizing unit and/or to drive a screw linearly and/or rotationally.

Moreover, protection is sought for a computer program product which is suitable preferably to operate a hydraulic system according to the invention and is suitable to be executed on a machine control system of a molding machine, comprising commands which, when executed by the machine control system, prompt the latter to receive measured values of at least one sensor and to carry out a valve regulation of at least one hydraulic valve on the basis of measured values of the at least one sensor.

### BRIEF DESCRIPTION OF THE DRAWINGS

Further details and advantages of the present invention are explained in more detail below with the aid of the description of the figures with reference to the embodiments represented in the figures, in which:

FIG. 1 shows a first embodiment of a hydraulic system according to the invention,

FIG. 2 shows a detail of the hydraulic system from FIG. 1,

FIGS. 3a, 3b show known embodiment variants of the state of the art,

FIG. 4 shows an embodiment according to the invention, and

FIG. 5 shows an embodiment of a molding machine.

### DETAILED DESCRIPTION OF THE INVENTION

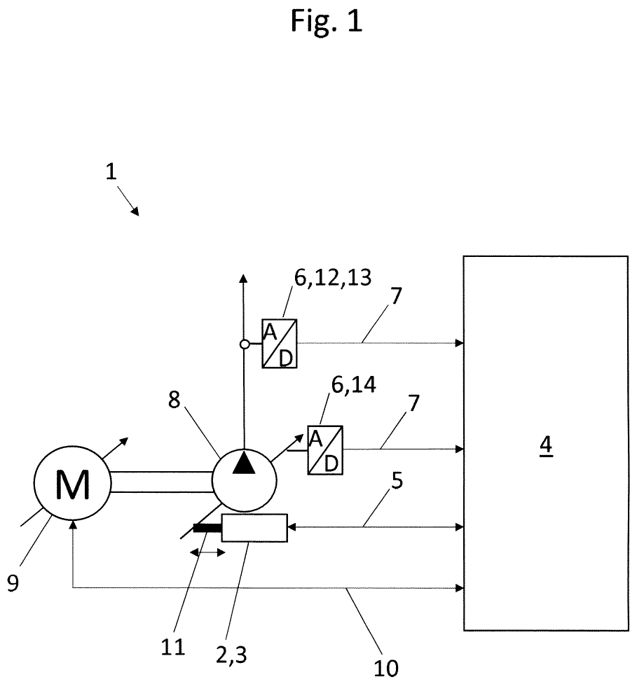

FIG. 1 shows a first embodiment of a hydraulic system 1 according to the invention.

The hydraulic system 1 has a fluid pump 8, by means of which a required pressure and/or volume flow of hydraulic fluid can be fed into the hydraulic system 1, for example from a reservoir or tank for hydraulic fluid.

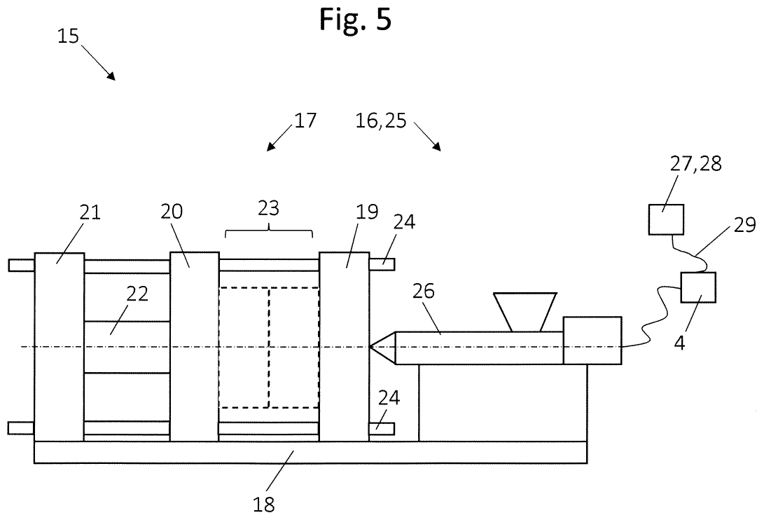

With the aid of this hydraulic system 1, a drive unit of a molding machine 15—such as for example a clamping unit 22, an injection unit 16 or a plasticizing unit 25—can be driven (reference may be made to FIG. 5 at this point).

The hydraulic system 1 represented in FIG. 1 furthermore has a drive 9, which is coupled to the fluid pump 8, in order to drive the fluid pump 8.

The drive 9 is formed by a variable-speed servomotor, which is connected to the machine control system 4 via the signal connection 10.

The machine control system 4 can be formed to control or regulate the drive 9 with respect to the rotational speed, in order thus to be able to control or regulate a drive power via the rotational speed of the drive 9 of the fluid pump 8.

The fluid pump 8 provided is formed adjustable with respect to its displacement volume. The fluid pump 8 represented here is implemented for example as an axial piston pump with adjustable swivel angle.

This swivel angle can be set via the hydraulic actuator 11, wherein the hydraulic actuator 11 can be controlled or regulated via the hydraulic valve 2 and the actuator 3 associated with the hydraulic valve 2.

This actuator 3 and/or the hydraulic valve 2 are connected to the machine control system 4 via the first signal connection 5.

The swivel angle of the fluid pump 8 can be detected by means of the sensor 6—here the swivel angle sensor 14 for example—wherein a measurement signal of the swivel angle sensor 14 can be supplied to the machine control system 4 via the second signal connection 7.

Moreover, a sensor 6 is provided in order to measure a pressure and/or flow of the hydraulic system 1, wherein the sensor 6 is formed as a pressure sensor 12 and/or flow sensor 13 and can provide a measurement signal to the machine control system 4 via the second signal connection 7.

In this embodiment of the hydraulic system 1, it is provided that the sensors 6, 12, 13, 14 are signal-connected to the machine control system 4 via the second signal connections 7 and the machine control system 4 is formed to carry out the valve regulation of the hydraulic valve 2 on the basis of measured values of the sensors 6, 12, 13, 14.

It can be provided that the machine control system 4 takes into account a pressure and/or flow prevailing in the hydraulic system 1 and/or a prevailing swivel angle of the fluid pump 8, in order to adjust the swivel angle of the fluid pump 8 and thus to regulate or control a pressure and/or flow of the hydraulic system 1 with respect to a predefined or calculated target value.

Furthermore, it can be provided that the machine control system 4 takes a rotational speed of the drive 9 into account in the control or regulation of the hydraulic valve 2 and/or even uses the rotational speed of the drive 9 as further control or regulating variable in addition to the hydraulic valve 2 for controlling or regulating the hydraulic system 1.

It can particularly preferably be provided that the machine control system 4 itself generates a preferably analog actuation signal and outputs it to the hydraulic valve 2 via the signal connection 5, wherein the actuator 3 actuates the hydraulic valve 2 according to the actuation signal of the machine control system 4.

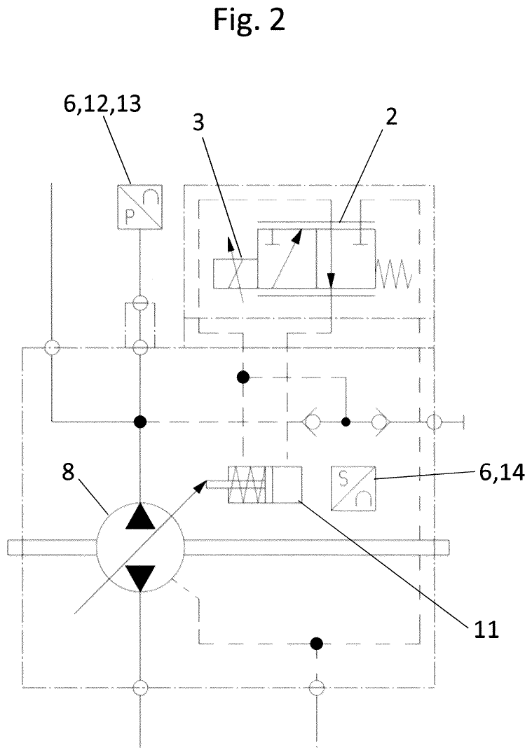

As can be seen in FIG. 2, the hydraulic system 1 can be formed in such a way that, via the hydraulic valve 2, a position of the swivel angle of the fluid pump 8 is set via the hydraulic actuator 11.

The hydraulic actuator 11 for setting the swivel angle of the fluid pump 8 is formed as a spring-return piston-cylinder unit.

The hydraulic valve 2 of the embodiment of FIG. 2 (which represents a detail view of the hydraulic system 1 of FIG. 1) is formed as a magnetically-operated, spring-return 3/2-way valve, wherein the actuator 3 of the hydraulic valve 2 is to be configured as the magnet operation represented, which can be actuated directly via an analog actuation signal of the machine control system 4.

It is hereby made possible that a correcting variable—more precisely: an actuation signal—of the machine control system 4 is known and this can be taken into account by the machine control system 4 in further control processes.

Thus, it is possible that the machine control system 4, by means of the hydraulic valve 2 and the hydraulic actuator 11, sets a displacement volume of the fluid pump 8 on the basis of a correcting variable resulting from the valve regulation.

It can be provided that the machine control system 4 is formed to generate and output the actuation signal for the actuator 3 of the hydraulic valve 2 taking into account a displacement volume of the fluid pump 8 and/or an operating state of the drive 9 of the fluid pump 8.

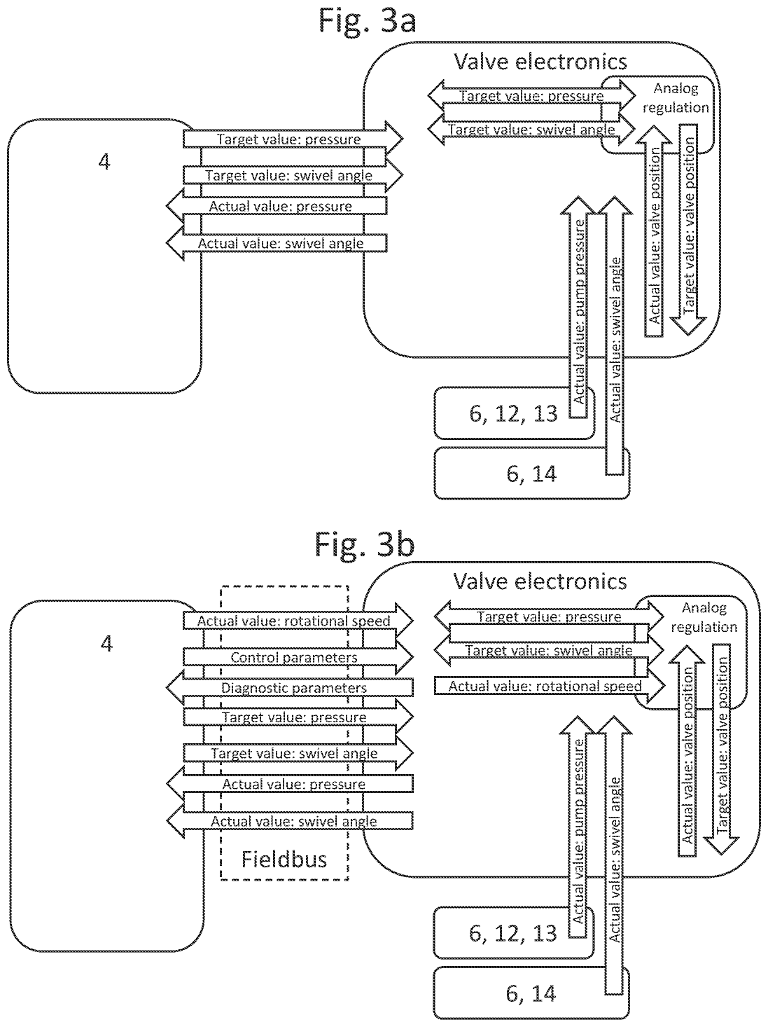

FIGS. 3a, 3b on the other hand show known control or regulation methods from the state of the art, wherein valve electronics separate from the machine control system 4 are provided on the hydraulic valve 2 in order to perform a control or regulation of the hydraulic valve 2.

The valve electronics accept sensor signals of the sensors 6, 12, 13, 14 and use these for analog (FIG. 3a) or digital (FIG. 3b) control or regulation of the valve until a target value of the hydraulic valve 2 is set.

However, the valve electronics communicate with the machine control system 4 only via target and actual values, wherein the valve electronics can for example receive a target value for a pressure of the fluid pump 8 transmitted by the machine control system and can return an actual value.

However, it is not possible or known from the state of the art that the machine control system 4 itself receives information learned or provided via correcting variables of the hydraulic valve 2, sensor signals of the sensors 6, 12, 13, 14 or other control parameters of the hydraulic valve 2, whereby it is not possible for the machine control system 4 to use these parameters or sensor signals in the regulation or control of further machine components.

In the case of a digital control or regulation of the state of the art, as represented by FIG. 3b, it is provided that the valve electronics are connected to the machine control system 4 via a fieldbus system, wherein further (diagnostic) parameter values can additionally also be transmitted to the valve electronics.

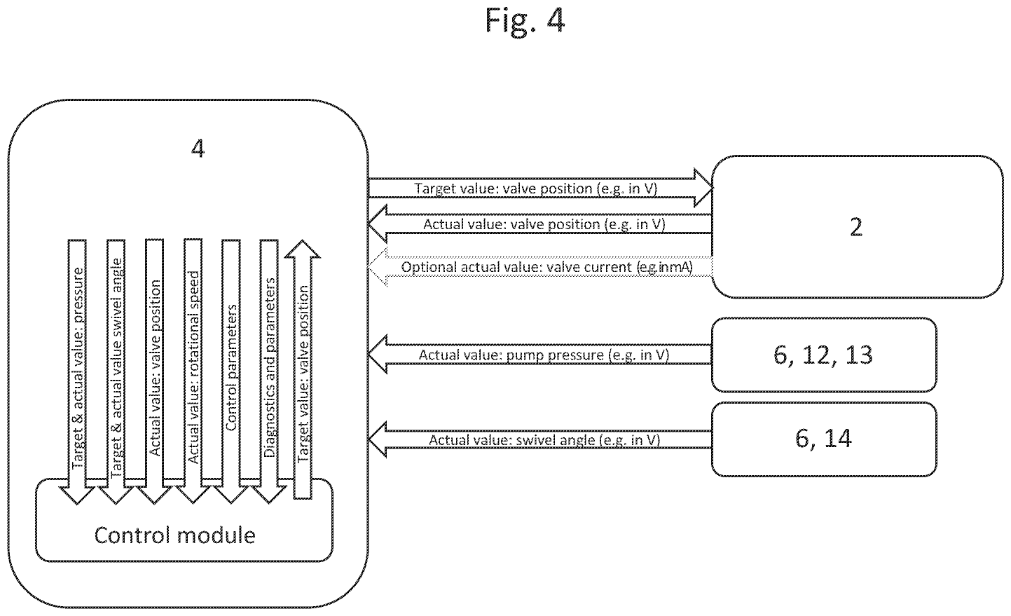

As can be seen on the other hand from FIG. 4 and the embodiment variant according to the invention represented in FIG. 4, it is provided according to the invention that the machine control system 4 communicates directly with the hydraulic valve 2, wherein, preferably analog, actuation signals can be sent directly to the hydraulic valve 2 by the machine control system 4 and thus these actuation signals are also present as actual values of the machine control system 4.

Furthermore, sensor measurement signals can be transmitted directly to the machine control system 4, wherein the machine control system 4 can adapt the calculation or output of the actuation values to the hydraulic valve 2 on the basis of the measured values of the sensors 6, 12, 13, 14.

The molding machine 15 represented by way of example in FIG. 5 is an injection-molding machine and has an injection unit 16 and a clamping unit 17, which are arranged together on a machine frame 18. The machine frame 18 could alternatively also be formed multi-part.

The clamping unit 17 has a fixed platen 19, a movable platen 20 and an end plate 21.

Alternatively, embodiment variants without end plate 21 are also possible. Such clamping units are referred to as two-plate clamping units.

The movable platen 20 is movable relative to the machine frame 18 via a symbolically represented clamping drive 22. The clamping drive 22 can be formed as a hydraulic drive unit which is operated via a hydraulic system 1 described previously.

Mold halves of a mold 23 can be clamped or fitted (represented dashed) on the fixed platen 19 and the movable platen 20.

The fixed platen 19, the movable platen 20 and the end plate 21 are mounted and guided relative to each other by the rails 24.

The mold 23 represented closed in FIG. 5 has at least one cavity. An injection channel, via which a plasticized material can be supplied by the plasticizing unit 25, leads to the cavity.

The injection unit 16 of this embodiment has an injection cylinder 26 and an injection screw arranged in the injection cylinder 26. This injection screw is rotatable about its longitudinal axis and movable along the longitudinal axis axially in the conveying direction.

These movements are driven via a schematically represented drive unit. This drive unit preferably comprises a hydraulic rotary drive for the rotational movement and a linear hydraulic drive for the axial injection movement, wherein the hydraulic drives can be operated via a hydraulic system 1 described previously.

The plasticizing unit 25 (and thus the injection unit 16) is in signaling connection with the central machine control system 4. Control commands are output for example to the plasticizing unit 25 by the central machine control system 4.

The central machine control system 4 can be connected to an operating unit 27 and/or a display device 28 via a signal-carrying connection 29 or can be an integral constituent of such an operating unit 27.

### LIST OF REFERENCE NUMBERS

1 hydraulic system
2 hydraulic valve
3 actuator
4 machine control system
5 signal connection
6 sensor
7 signal connection
8 fluid pump
9 drive
10 signal connection
11 hydraulic actuator
12 pressure sensor
13 flow sensor
14 swivel angle sensor
15 molding machine
16 injection unit
17 clamping unit
18 machine frame
19 fixed platen
20 movable platen
21 end plate
22 clamping drive
23 mold
24 rail
25 plasticizing unit
26 injection cylinder
27 operating unit
28 display device
29 signal-carrying connection

1. A hydraulic system for a molding machine with
at least one hydraulic valve, which contains an actuator for positioning the at least one hydraulic valve,
a machine control system realized separate from the at least one hydraulic valve,
a first signal connection between the machine control system and the at least one hydraulic valve, as well as
at least one sensor,
characterized in that the at least one sensor is signal-connected to the machine control system via at least one second signal connection and the machine control system is formed to carry out a valve regulation of the at least one hydraulic valve on the basis of measured values of the at least one sensor.

2. The hydraulic system according to claim 1, wherein the machine control system is formed to generate and output an actuation signal for the actuator of the at least one hydraulic valve from a correcting variable resulting from the valve regulation, with the result that the actuator can be actuated by the actuation signal transmitted via the signal connection.

3. The hydraulic system according to claim 2, wherein the machine control system is formed to generate and output an analog actuation signal for the at least one hydraulic valve.

4. The hydraulic system according to claim 1, wherein the hydraulic system has at least one fluid pump and a drive coupled to it, wherein the drive and/or the at least one fluid pump is preferably signal-connected to the machine control system with a further signal connection.

5. The hydraulic system according to claim 4, wherein the at least one fluid pump is formed adjustable with respect to its displacement volume, preferably is formed as an axial piston pump with adjustable swivel angle.

6. The hydraulic system according to claim 5, wherein at least one hydraulic actuator, preferably a piston-cylinder unit, connected in a fluid-carrying manner to the hydraulic valve is provided, which is formed to set a displacement volume of the at least one fluid pump.

7. The hydraulic system according to claim 1, wherein the machine control system is formed to set a displacement volume of the at least one fluid pump on the basis of a correcting variable resulting from the valve regulation by means of the at least one hydraulic valve and/or hydraulic actuator.

8. The hydraulic system according to claim 4, wherein the machine control system is formed to generate and output the actuation signal for the actuator of the at least one hydraulic valve taking into account a displacement volume of the at least one fluid pump and/or an operating state of the drive of the fluid pump.

9. The hydraulic system according to claim 1, wherein the at least one sensor is formed as a pressure sensor and/or flow sensor, wherein a signal representative of the pressure and/or flow can be provided to the machine control system.

10. The hydraulic system according to claim 1, wherein the at least one sensor is formed as a position sensor, preferably a swivel angle sensor.

11. The hydraulic system according to claim 1, wherein the hydraulic system has at least one drive unit for driving at least one machine component, preferably a clamping unit and/or plasticizing unit, of the molding machine, wherein the machine control system is formed to control or regulate a movement, speed and/or position of the at least one machine component.

12. A molding machine, preferably an injection-molding machine, with at least one hydraulic system according to claim 1.

13. A computer program product suitable to operate a hydraulic system, in particular according to claim 1, and suitable to be executed on a machine control system of a molding machine, comprising commands which, when executed by the machine control system, prompt the latter to receive measured values of at least one sensor and to carry out a valve regulation of at least one hydraulic valve on the basis of measured values of the at least one sensor.
